(19) United States
(12) Patent Application Publication
(10) Pub. No.: US 2003/0177388 A1
(43) Pub. Date: Sep. 18, 2003

(54) Authenticated identity translation within a multiple computing unit environment

(75) Inventors: Patrick S. Botz, Rochester, MN (US); John C. Dayka, New Paltz, NY (US); Richard H. Guski, Red Hook, NY (US); Timothy J. Hahn, Vestal, NY (US); Margaret K. LaBelle, Poughkeepsie, NY (US)

Correspondence Address: HESLIN ROTHENBERG FARLEY & MESITI PC, 5 COLUMBIA CIRCLE, ALBANY, NY, 12203, US

(73) Assignee: International Business Machines Corporation, Armonk, NY

(21) Appl. No.: 10/099,799

(22) Filed: Mar. 15, 2002

(51) Int. Cl. G06F 12/14; G06F 11/30; H04L 9/32; H04L 9/00

(52) U.S. Cl. 713/201

(57) ABSTRACT

An authenticated identity translation technique is provided based on a trust relationship between multiple user identification and authentication services resident on different computing units of a multiple computing unit environment. The technique includes, in one embodiment, recording user identification and authentication events occurring within the trusted domain, and making this information available to other computing units within the domain by generating tokens representative of the identification and authentication events. A token is forwarded with a request to one or more computing units of the domain, which in turn provide the token to a domain controller to translate user identities between respective computing units.

### CROSS-REFERENCE TO RELATED APPLICATION

This application contains subject matter which is related to the subject matter of the following application, which is assigned to the same assignee as this application and which is hereby incorporated herein by reference in its entirety:

“Apparatus and Method for Managing Multiple User Identities on a Networked Computer System”, by Botz et al., Ser. No. 09/818,064, filed Mar. 27, 2001.

### TECHNICAL FIELD

The present invention relates in general to identification and authentication within a multi-computing unit environment, and more particularly, to a global, authenticated identity translation technique within such a multi-computing unit environment.

### BACKGROUND OF THE INVENTION

Many different computer systems and platforms exist today. Over time, platforms have developed with different operating systems and different software requirements. Examples of these different environments include the AS/400, AIX, and 390 systems (marketed by International Business Machines (IBM) Corporation of Armonk, N.Y.), and Windows 2000 (marketed by Microsoft of Redmond, Washington). Since the requirements of operating systems typically differ, each system maintains its own user registry, which includes a list of users and associated information, such as user IDs and passwords, used to authenticate a user when access to the network is requested. A user may be a human user, or may be a software process assigned a local user identity, such as a print server. Each platform typically has its own administrative tools that allow a system administrator to add, delete, or modify user identities in the user registry. With a heterogenous network that has several different operating systems, this means that the system administrator must learn and become proficient in several different tools which handle identity management in their respective realms (e.g., platforms).

In addition, because each user has a user identity in the user registry for each platform the user wants to access, the user typically has several user IDs and passwords for the different platforms on the network. This results in having to manage multiple user identities for the same user using different administration tools. Further, this inhibits a generalized method of supporting application run-time inter-operation between systems employing disparate registry services.

In view of the above, a need exists in the art for a novel approach to authenticated identity translation within a multi-computing unit environment to, for example, facilitate run-time inter-operation between systems employing disparate registry services.

### SUMMARY OF THE INVENTION

The shortcomings of the prior art are overcome and additional advantages are provided through the provision of an authenticated identity translation method which includes: establishing an authenticated user identity responsive to an identification and authentication event within a domain comprising an initial authentication unit and a subsequent authentication unit, the identification and authentication event occurring at the initial authentication unit, the initial authentication unit and the subsequent authentication unit employing disparate user registries with different user identities; generating a token representative of the identification and authentication event to be forwarded to the subsequent authentication unit; and translating the authenticated user identity of the initial authentication unit to a local user identity of the subsequent authentication unit, wherein the subsequent authentication unit initiates the translation employing the token.

In an enhanced aspect, the domain further includes a logical domain controller function, and the translating includes using the token to translate using the domain controller the authenticated user identity to the local user identity, wherein the translating includes employing a global registry of the different user identities maintained by the domain controller to translate the authenticated user identity into the local user identity for the subsequent authentication unit.

Systems and computer program products corresponding to the above-summarized methods are also described and claimed herein.

Aspects of the present invention advantageously support application run-time inter-operation between disparate security registry services which employ different forms of user identification and authentication. In accordance with the authenticated identity translation technique disclosed herein, a caller of the service does not have to know which target system or systems a further request will be forwarded to in a multi-system environment. Further, using the present technique, user passwords exist only inside the protection offered by the security registry whereby a user initially authenticates, thereby facilitating administration of the system. Employing identity translation tokens in accordance with an aspect of the technique further provides trace delegation that encompasses multiple disparate security user registries. In addition, using a domain controller function to record identification and authentication events inside a domain enables management of a security state for a transaction in transit.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an example of a multi-server environment illustrating a problem addressed by one or more aspects of the present invention;

FIG. 2 depicts an example of one possible solution to the problem illustrated by FIG. 1;

FIG. 3 depicts one example of a multiple computing unit environment incorporating and using certain identity translation capabilities, in accordance with an aspect of the present invention;

FIG. 4 depicts an examplary identification and authentication process for the environment of FIG. 3, in accordance with an aspect of the present invention;

FIG. 5 is one example of interface service logic employed in constructing a signed identity translation token (ITT), in accordance with an aspect of the present invention;

FIG. 6 is one example of interface service logic employed in obtaining an identity translation token reference (ITTR), in accordance with an aspect of the present invention;

FIG. 7 is one example of domain controller logic employed in resolving an authenticated user identity to a local user identity of a request server, in accordance with an aspect of the present invention;

FIG. 8A depicts one embodiment of a translation token derived from an identification and authentication event and used to identify a user for a subsequent request server, in accordance with an aspect of the present invention;

FIG. 8B depicts one embodiment of a translation token reference comprising an index to a stored translation token at the domain controller, and which is used to identify a user for a subsequent request server, in accordance with an aspect of the present invention;

FIG. 8C depicts one embodiment of signature information used by interface services logic to sign a translation token, in accordance with an aspect of the present invention;

FIG. 9 depicts one example of a multiple computing unit environment, where multiple subsequent request servers access the global registry within the domain controller for implementing authenticated identity translation, in accordance with an aspect of the present invention;

FIG. 10 depicts another example of a multiple computing unit environment, where multiple users access the environment through multiple initial authentication servers which then request processing from multiple subsequent request servers, wherein the subsequent request servers access the global registry within the domain controller to identify and authenticate user access requests, in accordance with an aspect of the present invention;

FIG. 11 depicts another example of a multiple computing unit environment which illustrates forwarding of a token created by an initial authentication server to a subsequent request server by way of the user, in this case a web browser, in accordance with an aspect of the present invention;

FIG. 12 illustrates a multiple partition computing environment where user identification and authentication is performed between partitions, in accordance with an aspect of the present invention; and

FIG. 13 depicts still another example of a multiple computing unit environment, where multiple users access the environment through multiple initial authentication servers, each of which also functions as a request server for another authentication server, with user identities for the subsequent request servers being resolved through the global registry maintained at the domain controller, in accordance with an aspect of the present invention.

### BEST MODE FOR CARRYING OUT THE INVENTION

In accordance with one or more aspects of the present invention, a method for identification and authentication translation within a multi-computing unit environment is provided. The method facilitates signing on within a computing environment including, for example, multiple servers employing disparate user registries; and includes dynamically translating an authenticated user identity on one server to an associated local identity on at least one other server of the computing environment.

The problem addressed by the authenticated identity translation technique disclosed herein is explained further below with reference to FIGS. 1 & 2.

FIG. 1 depicts a multi-computing unit system, including an initial authentication server 102 employing a local user registry 106, and a request server 104 employing a local user registry 108. Those skilled in the art will understand that although described herein with reference to servers, the authenticated identity translation technique presented is applicable to any type of computing environment employing multiple computing units, and is particularly advantageous in a heterogeneous computing environment.

In the example of FIG. 1, the initial authentication server and the request server are assumed to be built on disparate platforms, with local user registries 106 and 108 being distinct. A user 100 is identified and authenticated 110 (via, for example, Secure Sockets Layer (SSL) protocol) on the initial authentication server using a corresponding user identity from user registry 106. Once identified and authenticated, the user may use, for instance, an application (not shown) running on the initial authentication server. If the application should request a service on the request server, then the initial authentication server forwards 112 a request to the request server. The problem now is how to identify and authenticate the user at the request server.

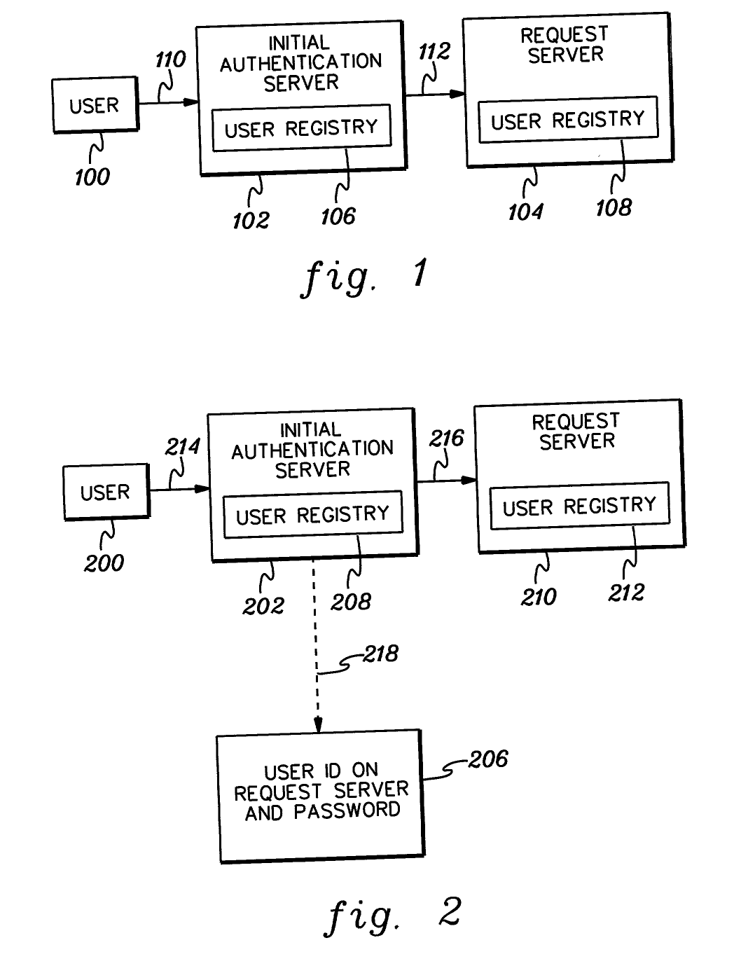

Although “single-signon” products adressing this problem exist, such as Tivoli Global Sign-On (offered by Tivoli Systems Inc., an International Business Machines Company), such products are based on a product specific “mapping file” that contains at the initial authentication server a particular user's ID and password on some potential “target” server, platform or application. A current approach taken by these “single-signon” products is described below with reference to FIG. 2.

The system of FIG. 2 includes an initial authentication server 202 using a local user registry 208, a request server 210 using a local user registry 212, and a side file 206 containing user IDs and passwords for the request server. Similar to the example of FIG. 1, the initial authentication server and the request server are assumed to be built on different platforms, with disparate user registries 208, 212. A user 200 is identified and authenticated 214 at the initial authentication server using a corresponding user identity from user registry 208. Should initial authentication server 202 wish to forward a request 216 to the request server 210, a user ID and password for the request server 210 is obtained 218 from side file 206 and is included with the request 216. The request server 210 then signs the user on like any other local request.

The application-owned mapping file approach described above leads to the following set of problems. First, mapping file entries are “target system based”, meaning that the caller of the service needs to know the target system(s). Also, the mapping file entry for a particular target platform, application, or middle-ware security service should contain an authenticator for the user in order to affect a “sign-on” for the user at the target unit. Usually the authenticator is the user's password, leading to administrative problems since passwords change from time to time, as well as to security concerns because the user's password would exist outside the protection offered by the local user registry and one-way encryption.

Further, since there are multiple single-signon products implementing similar functions in applications and middle-ware today, multiple different and non-compatible mapping file implementations exist which inhibit using disparate computing resources as an inter-operable set. Moreover, the target platform, application, or middle-ware security service has no way of distinguishing a sign-on that comes to it from another platform, application, or middle-ware security service, that has already accomplished the identification and authentication, from any other sign-on request. That is, from the perspective of the target platform, application, or middle-ware security service the “history” is lost. Still further, there is no general method or protocol for managing security state of a transaction which is in transit. That is, once a request has been forwarded, there is currently no way to stop the request from being forwarded again and again, even though the user may have been revoked from the original, local user registry.

Taken together, these problems make applications that fan to multiple disparate back-end request servers, or which multi-hop to multiple request servers, or combinations of these cases, unfeasibly problematic to implement using the approach of FIG. 2. This situation is a principle inhibitor to the development of distributed applications which might otherwise be designed to exploit multi-platform, multi-application computing resources, as if the resources were a single inter-operating set.

One way to solve this problem is to force all applications and operating systems to share a common user registry. This approach may be viable in a homogenous environment, i.e., in a network that only has computers of the same platform type. However, implementing this approach on a heterogenous network that includes several different systems would require that each operating system and each application be re-written to access some common user registry, rather than its local user registry. This is simply not a workable solution.

Prior to describing embodiments of the present invention, the following definitions are presented for use herein:

Authenticated identities translation (AIT): A set of services providing an infrastructure to support run-time cooperation between disparate security registry user identification and authentication functions, thus facilitating advanced forms of single-signon and trace delegation processes.

Trust Domain: A set of servers, which have been administratively defined to a domain controller, having a trust relationship such that an identification and authentication event on one server within the trust domain will be accepted on other servers of the trust domain.

Interface Services: Interface services function as a server's interface to the domain controller. The interface services are used by the initial authentication servers and request servers to pass and receive information between the respective server and the domain controller. The interface services contain local identification and authentication event recorder (LIAR) functions and request server identity resolution (SUIR) functions.

Initial Authentication Server: A particular server within a defined trust set of servers where a user first identifies and authenticates using the security services locally available to the initial authentication server.

Request Server: A server within the defined trust set of servers other than the initial authentication server where a user's computer service request is processed either completely or in part.

Local Identification and Authentication Event Trapping and Recorder (LIAR): A functional component of the interface services that is invoked by the operating system, application, or middle-ware security user identification and authentication services to obtain, for example, an identity translation token (ITT) or an identity translation token reference (ITTR).

Server User Identity Resolution (SUIR): A functional component of the interface services that is invoked by a request server to resolve a user identity that is represented by a token and to authenticate a user at the request server.

Identification Translation Token (ITT): A transportable and secure (from modification) document that records the details of how, when, where, and using what local user id an end-user has identified and authenticated to a particular server that is participating in the trusted domain of servers. An ITT is effectively a “credential” that can be used to identify and authenticate a computer service request that is forwarded to a computer server that is participating in a trusted domain of servers.

Identification Translation Token Reference (ITTR): A secure token which refers to an ITT that is being managed and stored by the domain controller. In one embodiment, an ITTR is a position index of a stored ITT.

Trust Policy: Policy information optionally related to specific users who are defined to the trusted domain, and/or to initial authentication servers and request servers that are defined to the trust domain.

User (Trust Domain User): An individual client-user or process that has a system or application user id defined in one or more systems or application user registries that are part of the trust domain set of registries.

Enterprise Identity Mapping (EIM): A set of computing services that maintain and make available information detailing an enterprise user's individual identity names in multiple security user registries of multiple computer platforms, applications or middle-ware. The enterprise identity mapping (EIM), which is described in the above-incorporated patent application entitled “Apparatus and Method for Managing Multiple User Identities On A Networked Computer System”, may be implemented on top of Light Directory Access Protocol (LDAP).

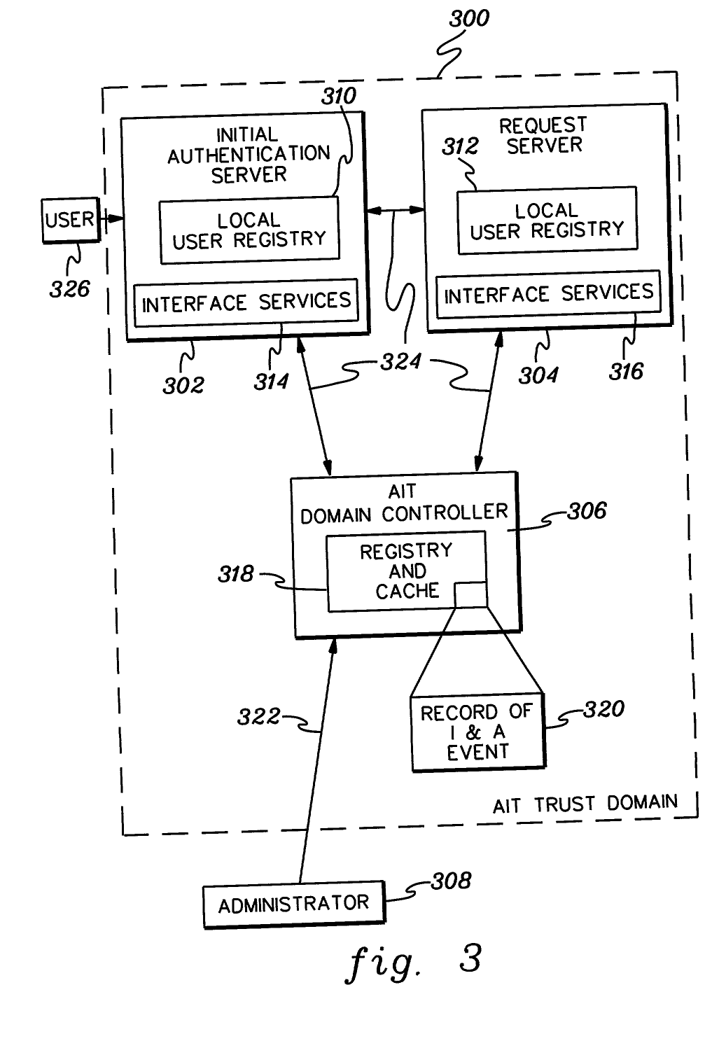

One embodiment of a computing environment incorporating and using aspects of the present invention is shown in FIG. 3. The environment includes an initial authentication server 302 and a request server 304. Each server includes its own user registry 310, 312. A user registry (also referred to herein as a local user registry or security registry) contains information on users having access to the respective server, such as user IDs and passwords. In one example, the initial authentication server may be a zSeries 900 server (offered by International Business Machines Corporation (IBM)) running a z/OS operating system, and the request server may be an iSeries 830 server (offered by IBM), running an OS/400 operating system. z/OS and OS/400 are operating systems offered by International Business Machines Corporation.

The initial authentication server includes an identification and authentication component or service to identify and authenticate a user 326. In one embodiment, identification and authentication is accomplished by way of the operating system, for instance, implementing an appropriate plug-able authentication module in a UNIX-like environment. In another embodiment, the identification and authentication component is an application running on the initial authentication server or middle-ware, such as WebSphere (offered by IBM).

A trust relationship is defined between the initial authentication server and the subsequent request server. This trust relationship means that among security user identification and authentication services, a user identification and authentication performed by one service is understood and trusted by another service within the defined trusted set of services. This trust relationship is also referred to herein as a trust domain, with domain 300 being one example.

In order to control and provide integrity for the dynamic translation of authenticated user identities, authenticated identity translation (AIT) in accordance with aspects of the present invention assumes that a condition of trust is established between the components of the system involved in the translation of authenticated identities. The components involved are, in this case, the user identification and authentication services along with their associated local user registries that are in use within the operating system platforms (such as z/OS or OS/400), applications (such as SAP, offered by IBM), middle-ware (such as WebSphere offered by IBM), or web services that are cooperating. The services that support the definition of trust between such services include the semantics to establish limits of trust according to certain definable conditions. In one embodiment, such conditions (referred to as the trust policy), may include the method of identification and authentication used initially and a list of individual users to be included or excluded from the mapping and authentication process.

In accordance with one or more aspects of the present invention, trust domain 300 is established to include initial authentication server 302, request server 304, as well as authenticated identity translation (AIT) domain controller 306. The trusted set of servers (e.g., the initial authentication server and the request server), can be defined 322 to the AIT domain controller by an Administrator 308.

The AIT domain controller 306 can be implemented as a set of services accessible via Transmission Control Protocol/Internet Protocol (TCP/IP) Secure Sockets Layer (SSL) interface by servers of the trust domain. Further, the AIT domain controller could run on any server within the trust domain. The AIT domain controller processes requests according to the trust policy, which defines boundaries of trust and is maintained, for instance, within a Light Directory Access Protocol (LDAP) accessible storage. (LDAP storage is described, for example, in a publication by House et al. entitled E-Directories Enterprise Software, Solutions and Services, Addison-Wesley publisher (2000).) The trust policy includes, in one example, Uniform Resource Locators (URLs) of the initial authentication and request servers defined to be within the trust domain. In a further embodiment, a public key of each defined server is included in the LDAP entries. The AIT domain controller is, in one example, a trust broker between servers who are participating in the trust domain.

The AIT domain controller exploits global user identity information placed, for example, in a LDAP-accessible directory by the above-referenced Enterprise Identity Mapping (EIM) processing. In this example, authenticated identity translation uses this information to achieve dynamic translation of a user's authenticated identity within the scope of a given user security registry, to an authenticated user identity within another user security registry.

Further, in accordance with an aspect of the present invention, interface services 314 and 316 are provided to interface the initial authentication server and the request server to the AIT domain controller. In one embodiment, interface services are implemented within an AIT server interface daemon, with the server interface daemon running on each server within the trust domain.

In one procedural programming embodiment, the AIT domain controller functions as a server in the classic client-server model. The clients in this model would be the interfaces services 314, 316 of the servers.

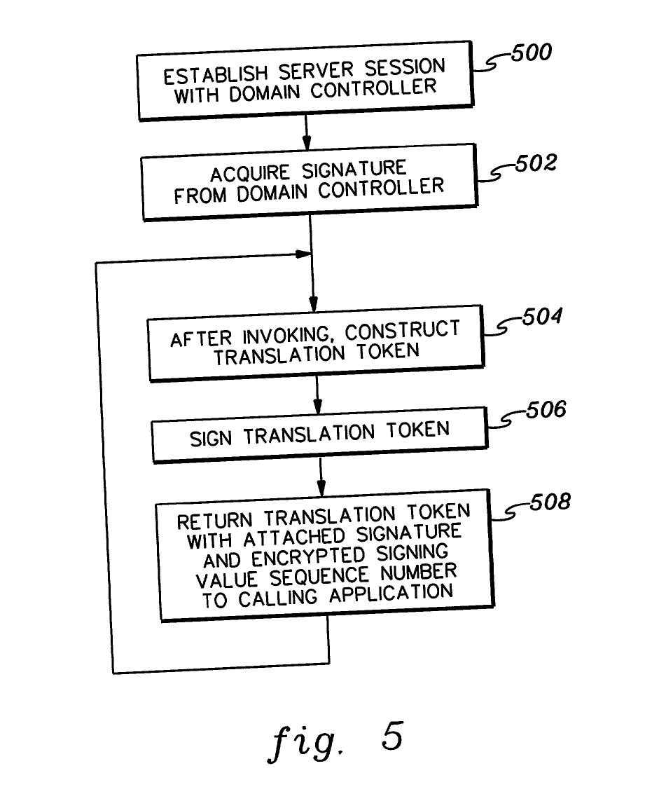

The interface services facilitate three basic functions: establishing upon initialization a long running secure connection 324 with the AIT domain controller, performing local identification and authentication event recording (LIAR) for the initial authentication server, and resolving a local user identity (SUIR) for the request server. These functions are described in greater detail below with reference to FIGS. 5-7. As one example, the long running secure connection could be a 128 bit Secure Sockets Layer (SSL) connection. In another example, the long running secure connection might be a Hipersocket connection in z/OS. The interface services, in one embodiment, may start with platform startup and recover automatically.

The AIT domain controller internally manages a domain controller server table that contains information describing and relating each instance of interface service that has established a server session with the domain controller.

As one example, local identification and authentication event recording could be performed upon user identification and authentication, by a local identification and authentication event recorder (LIAR) function of the interface services 314 at the initial authentication server. In one case, an identification and authentication event is recorded globally 320 in cache 318 of the AIT domain controller.

Resolving user identity at the request server can be performed by a server user identity resolution function (SUIR) of the interface services 316. This function can be initiated by a conventional identification and authentication component of the request server 304.

The above-discussed functions of the interface services can be invoked by the initial authentication server and the request server via, for instance, a call-return interface, for example the Inter-Process Communication (IPC) facility in UNIX.

As a further example, the interface services for a z/OS platform could be implemented as new System Authorization Facility (SAF) callable services that connect to an LDAP server (not shown), which may also function as the AIT domain controller.

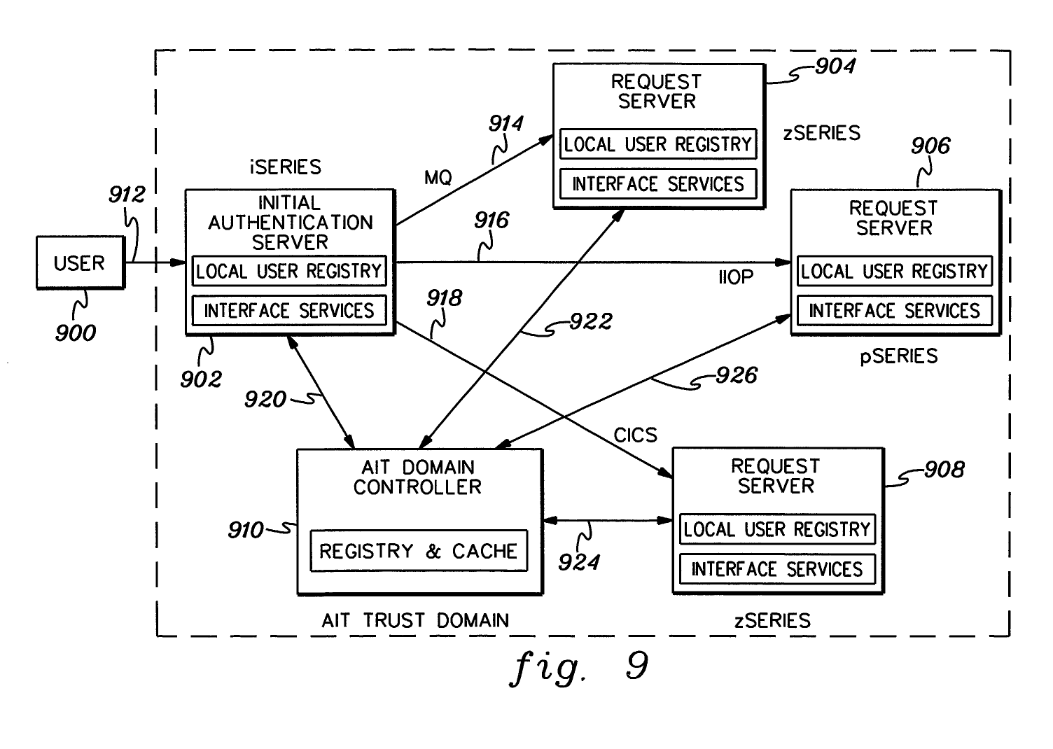

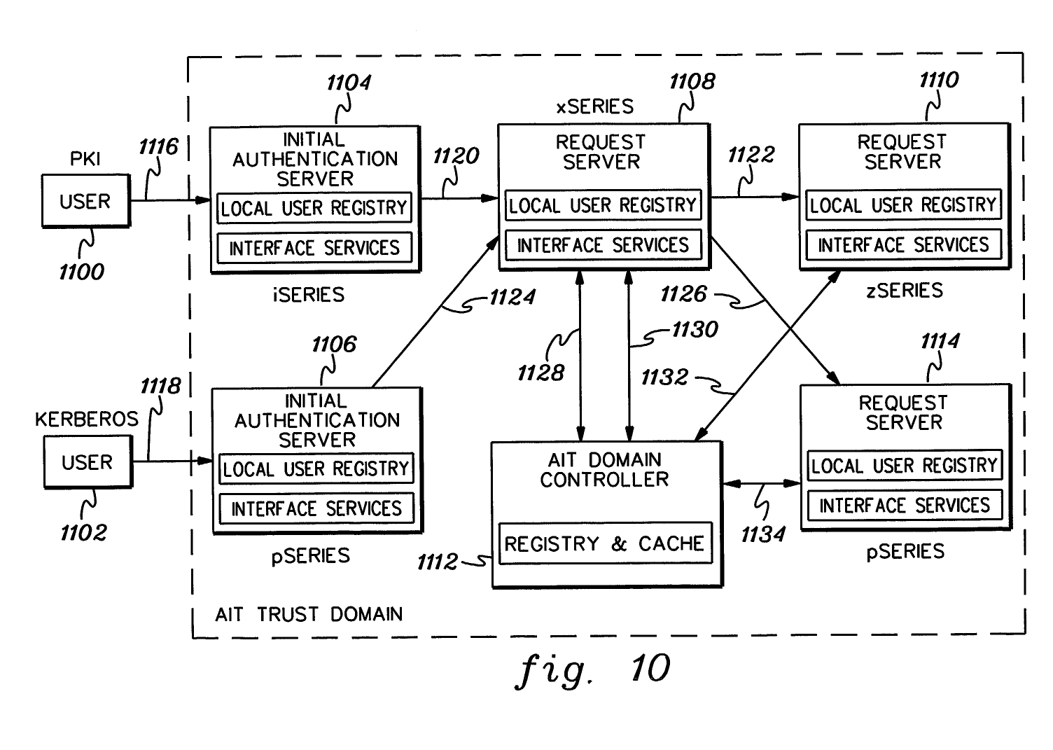

The above-described computing environment and servers are only offered as examples. The present invention could be incorporated in or used with many types of computers, processors, servers, systems, workstations and/or other computing environments without departing from the spirit of the invention. For example, one or more of the computing units could be based on a UNIX architecture or may include an Intel PC architecture. In another example, the present invention could be incorporated into another computing environment such as the emerging web services computing model. With the web services computing model, the various AIT logical processes, e.g., Domain Controller and interface services could be implemented as published and subscribed to web accessible services. Likewise, ITTs and ITTRs could be stored as published XML documents which could be further implemented using the Security Assertion Markup Language (SAML), which is a proposed standard. Additionally, while some of the embodiments described herein include only one initial authentication unit and one request unit, multiple initial authentication units and request units could be used as explained further below in connection with FIGS. 9-13.

Moreover, a user could be any individual client-user or process, such as an application server daemon, that has a system or application user ID defined in one or more user registries that are part of the trust domain set of registries. Furthermore, identification and authentication could be performed by operating systems, applications, middle-ware, or a combination thereof. Also, the aforesaid methods involve no specific requirements for the operating systems used in the servers, or for the applications and/or middle-ware used to identify and authenticate users. The interface services can run either as a server daemon, or as an extension to a kernel. The interface services' configuration could be stored in a LDAP-accessible storage and could be retrieved upon server session initialization.

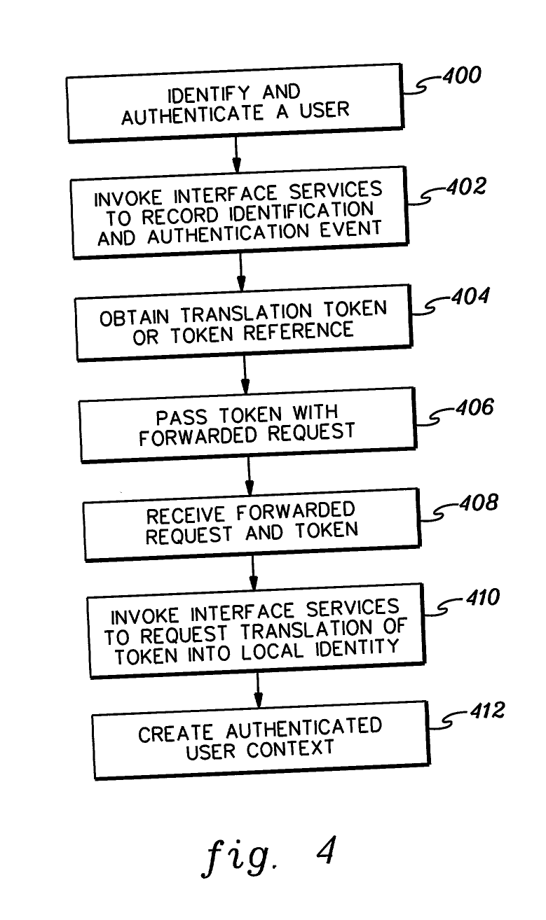

Authenticated identity translation processing in accordance with an aspect of the present invention is described below with reference to FIG. 4.

Initially, a user invokes an application or middle-ware running at an initial authentication server to request an identification and authentication. The user's credentials, e.g., user ID and password, are verified in the local user registry, and if accepted, the user is identified and authenticated at the initial authentication server 400. In one example, identification and authentication could be accomplished over a 128 bit SSL connection between the user and server. In another example, the user could be identified and authenticated using Kerberos (i.e., a network authentication protocol available from Massachusetts Institute of Technology).

The initial authentication server could be running a UNIX-based operating system, and have a plug-able authentication module (PAM) interface. In such an embodiment, the application or middle-ware of the server could invoke the PAM interface to authenticate the user. In another embodiment, the application or middle-ware could invoke any conventional built-in identification and authentication technology to authenticate the user.

Once identification and authentication is performed, the interface services can be invoked to facilitate recordation 402 of the identification and authentication event within the trust domain, for example, at the initial authentication server or at the domain controller. Both approaches are explained further below.

The interface services form and return 404 to the calling application either an identity translation token (ITT), if the event is recorded locally, or an identity translation token reference (ITTR), if the event is recorded globally by the AIT domain controller. As described above, an identity translation token is, in one embodiment, a record of the identification and authentication event, securely formatted for transportation by the interface services. An identity translation token reference is, again in one embodiment, an encrypted and encoded reference to the globally stored record of the identification and authentication event, i.e., to the ITT stored at the domain controller.

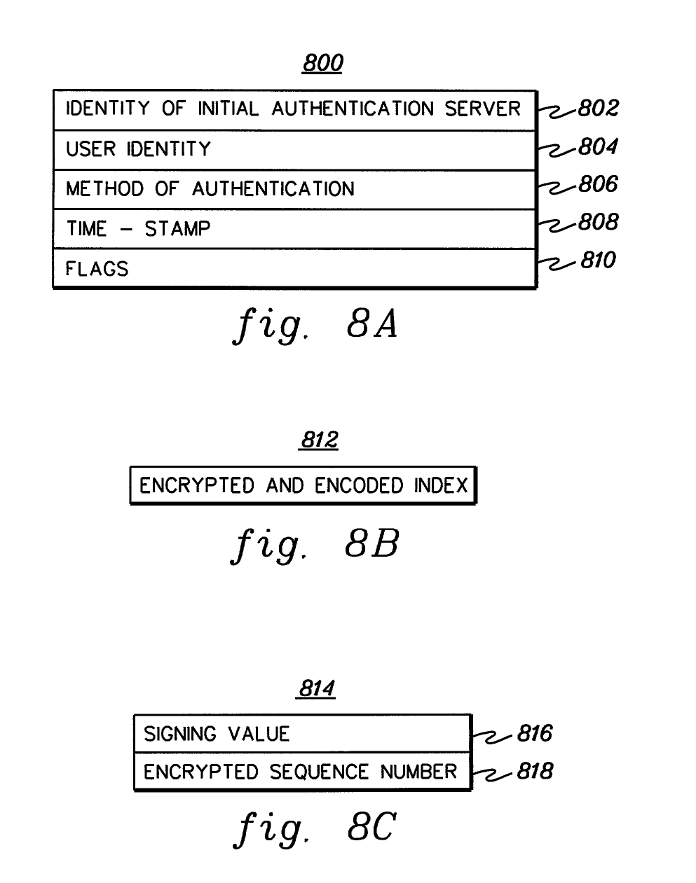

An identity translation token or an identity translation token reference is subsequently used by the initial authentication server to notify other servers within the trust domain of the identification and authentication event. One example of an identity translation token is depicted in FIG. 8A, while an example of an identity translation token reference is depicted in to FIG. 8B, both of which are described further below.

Continuing with the processing of FIG. 4, the token is passed by the initial authentication server with the user request or transaction propagation, to the request server 406. As one example, the token could be passed with the user request in the security fields for the request. Forwarding of the token in such a manner can be readily implemented by one skilled in the art.

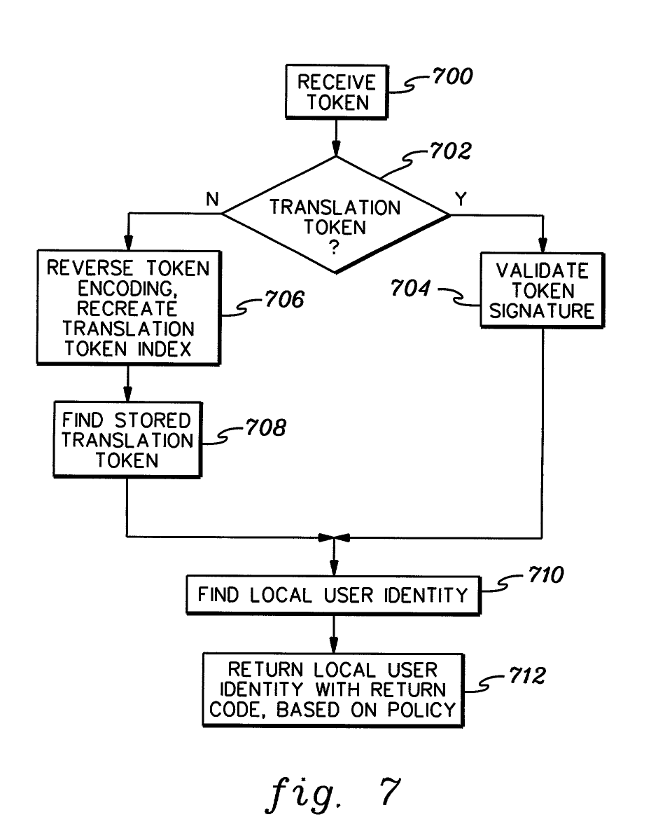

Upon receiving 408 a request including the token, the request server extracts the token from the communication flow and invokes 410 its interface services to translate the token into a local user identity. In one embodiment, this translation involves sending the token to the AIT domain controller where the translation is performed. Thereafter, the local user identity is returned to the request server. One example of domain controller logic to translate a user identity is discussed below with reference to FIG. 7.

Subsequent to receiving the local user identity from its interface services, an identification and authentication service of the request server creates an instance of the user's identified and authenticated local identity, in effect signing the user on 412. In another embodiment, the identification and authentication service of the request server establishes a processing environment with the user's local identity. For example, in UNIX based environments, the request server “forks” a new process and assigns it the now locally known user ID. The identification and authentication (I&A) service of the request server is embodied by whatever I&A service that is conventionally in use at this server, enhanced to invoke SUIR functions when an ITT or ITTR is encountered instead of a known credential such as a user id or password.

One example of the above-noted, local identification and authentication event recorder (LIAR) processing for the interface services is shown in FIG. 5. This LIAR processing can be employed to construct an identity translation token (ITT).

Upon a server's initialization, its interface services establish a server session with the domain controller. This includes, for instance, establishing a long running secure connection between the interface services logic of the server and the domain controller 500.

The LIAR processing then acquires one or more signing value from the AIT domain controller 502. The signing values can be generated and managed by the AIT domain controller, and are used to securely sign identity translation tokens (ITTs). Signing values may be generated during initialization of the interface services, and also upon further request by the interface services. A copy of each signing value issued to the interface services logic is retained by the AIT domain controller. An example of a signing value is described further below with reference to FIG. 8C.

After a user is identified and authenticated at the initial authentication server, identification and authentication event data is passed to the interface services and the LIAR function of the interface services is called. In one example, the event recorder function could be called by the application that identified and authenticated the user at the initial authentication server. After being invoked, the event recorder function uses the data to construct an identity translation token at the initial authentication server 504.

The translation token is then signed by the LIAR function using a signing value acquired earlier from the domain controller 506. If all signing values have been consumed, the interface services logic requests that the domain controller generate additional signing values for the current server session.

After signing, the LIAR function returns a signed translation token to the calling application 508. The translation token now has attached to it the signature and the encrypted signing value sequence number, and is hereafter referred to as a signed translation token. The application saves the signed translation token in, for example, local memory, maintaining an association between the saved token and the local identity of the user. Later, when the application needs to perform a remote sign-on or a transaction request for the user, the application includes the signed translation token with the request. The LIAR function is then finished until receipt of a next identification and authentication event.

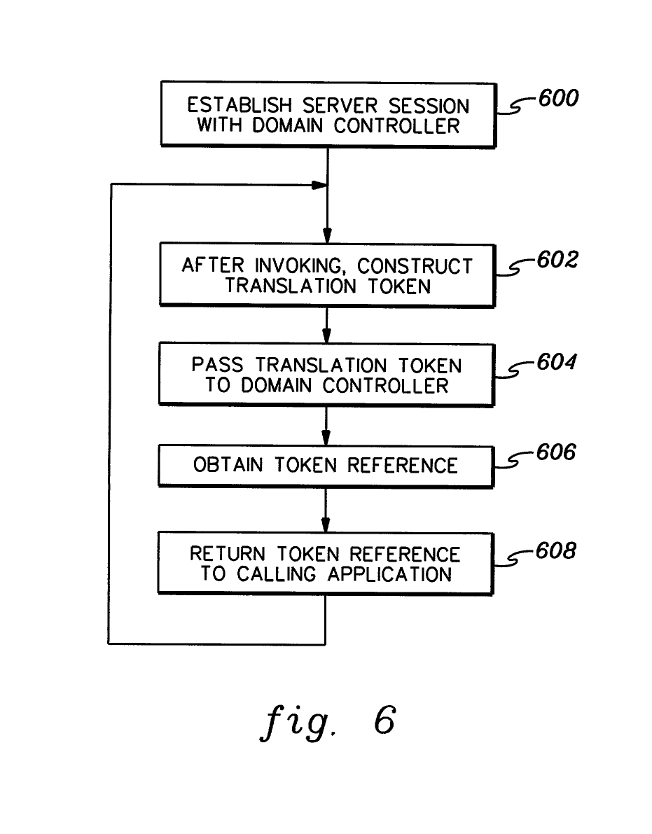

By way of further example, an identity translation token could be managed by the AIT domain controller, with an identity translation token reference (ITTR) being used for propagation with a server's transaction request or to perform remote sign-on. One example of logic for constructing an identity translation token reference is shown in FIG. 6.

Initially, the interface services logic establishes a server session with the domain controller 600, e.g., during initialization. This initialization includes, for instance, establishing a long running secure connection; for example, a 128 bit SSL connection between the server and the domain controller.

After a successful user identification and authentication event, the server invokes the LIAR function of the interface services logic, this time to record the identification and authentication event globally. Upon being invoked, the recorder function again constructs an identity translation token using the identification and authentication event information 602.

Once the identity translation token has been constructed, the LIAR function sends the token to the AIT domain controller over the secure connection 604. The domain controller stores the translation token in, for instance, LDAP-accessible storage within the trust domain. An identity translation token reference is created commensurate with the translation token's storage. This token reference contains for instance, an encrypted and encoded index to the identity translation token's position in storage. The token reference is returned to the server's function 606.

The recorder function then returns the token reference to the calling application 608, and stops until a next identification and authentication event occurs at the server.

In one embodiment, the calling application caches the token reference in memory in association with the user session. Later, when the application needs to perform a remote sign-on or a transaction request for the user, the application can include this cached token reference for forwarding with the request to the subsequent server.

When the request server receives a request forwarded from another server and recognizes an identification and authentication attempt by way of the authenticated identity translation concepts disclosed herein, the request server extracts the translation token or token reference from the communication flow and employs the server user identity resolution (SUIR) function of its interface services logic to obtain from the domain controller a local user identity of the user who was already authenticated at the initial authentication server. One example of AIT domain controller logic for resolving a user's identity at the subsequent or request server is described below with reference to FIG. 7.

When the AIT domain controller receives a token 700 from the SUIR function of a server's interface services, the controller determines 702 whether this token is an identity translation token (ITT) or an identity translation token reference (ITTR). If a translation token is received, then the signing value of the translation token is validated 704 using a copy of the signing value retained at the AIT domain controller when the signing values were originally issued to the originating interface services logic. The encrypted signing value sequence number within the signed translation token is decrypted, then used to determine the correct signing value, within the retained set of signing values, to use.

Otherwise, if the domain controller receives an token reference, then the controller reverses the token reference's encoding and encryption to recreate an identity translation token index 706, which is then used to look up and access the particular identity translation token stored within the domain controller memory, or in storage accessible by the controller 708.

For security reasons, if a token reference fails to resolve into a valid index reference, then it may be assumed (in one embodiment) that the token reference has been tampered with. This in turn could result in a security violation return code being passed back to the SUIR function, and subsequently to the invoking request server process, as well as in the generation of an appropriate logging record.

Continuing with FIG. 7, the AIT domain controller can reference the identity translation token and know the details of how the user was originally identified and authenticated, including what the user's identity is on the initial authentication server user's registry. Using this information, the AIT domain controller employs a translation mechanism to find or correlate the corresponding local user identity on the request server user registry. In one embodiment, this translation mechanism can employ an Enterprise Identity Mapping (EIM) process such as described in the above-incorporated patent application entitled: “Apparatus and Method for Managing Multiple User Identities On A Networked Computer System”. With the ITT, the AIT domain controller has access to an Enterprise Identity Mapping base entry for this user, which may contain an additional specific trust policy set for the user.

Next, the AIT domain controller accesses policy information about both the request server and the initial authentication server. In one embodiment, the trust policy for the user, the request server, the initial authentication server and trust domain is assumed to be available to the controller. In this embodiment, the domain controller uses the trust policy to determine whether the user sign-on or transaction request is to be considered authenticated or not, and an appropriate return code is generated based on this consideration.

As one example of a trust policy condition, a security service running at the request server may accept any user identification and authentication event from servers running AS/400, z/OS or using a Digital Certificate, but will refuse an identification and authentication event from a Windows 95 machine. Thus, if the return code specifies that the user is identified and authenticated at a Windows 95 machine, the user will not be able to sign on to the request server.

The local user identity on the request server is next returned 712 to the SUIR function, along with an appropriate return code. The request server uses the local user identity and return code to authenticate the user by either creating an instance of the user's identified and authenticated user identity or by establishing a processing environment with the user's local identity. The implications of this are that the local resource access control and auditing policies, including user groups and roles that the user may be assigned to, now apply to this user without further logical processing and administrative effort.

As discussed above, the identity translation token (ITT) can be used as a user's sign-on credential when the user's service request is forwarded to another computing unit within the same trust domain. One example of an identity translation token is shown in FIG. 8A.

In this example, the identity translation token 800 contains the following information:

An identity of the initial authentication server where the user was first identified and authenticated 802.

An identity of the user at the at the initial authentication server 804.

A method of authentication used 806. Examples of specific authentication methods include: Kerberos, including Kerberos Realm name; Digital Certificate, including Public Key Infrastructure (PKI) trust chain; an operating system identification and authentication service, e.g., IBM's z/OS system's Resource Access Control Facility (RACF) User-ID and Password or RACF including RACF Realm Name and how the user was authenticated to RACF, e.g., by PKI, Kerberos, or basic authentication using user id and password or PassTicket; and LDAP, including LDAP server name and an authentication method accepted by LDAP (list similar to RACF list).

A time-stamp noting the time that the request for an identity translation token was made, or the approximate time of the identification and authentication 808.

Flags 810 to indicate, e.g., that the entry is:

[1] single-use, in which case the ITT is retired immediately after the first reference by the request server; or

[2] forwardable, that is the identity translation token may be referenced by multiple request servers.

The status of the flags can be controlled by the trust policy.

In one embodiment, a schema for an identity translation token can be downloaded to the interface services logic in an Extensible Markup Language (XML) form from the domain controller; for example, during server session initialization or in response to a directive from the AIT domain controller.

As explained above, in the case when an identity translation token (ITT) is managed by the AIT domain controller, an identity translation token reference (ITTR) is used as a user's credential when the request is forwarded. One example of such an ITTR is discussed below with reference to FIG. 8B.

Each domain controller managed ITT entry is assigned, for instance, a specific indexed position in the AIT domain controller's retention space. The index position number is encrypted with a strong encryption algorithm, e.g., triple DES or equivalent, and encoded into a printable character string thus forming the ITTR. In this embodiment, such keys could be generated randomly at Domain Controller startup and remembered across Domain Controller sessions, in a secure repository, such as IBM's Integrated Cryptographic Support Facility, so that the algorithm could try the next previous, and so on. This would allow the AIT domain controller to be reinitialized without obsoleting any identity translation token references that are in transit.

By way of example, in one embodiment, the token reference (ITTR) may be a printable 16 character string. In this model of the token reference, the 16 characters allowed might be limited to the characters lower case ‘a’-‘z’ and numbers ‘0’-‘9’ for a total of 37 symbols. The information bandwidth of the identity translation token reference in such an embodiment would be 37¹⁶≅2⁸⁴.

If an identity translation token is to be managed by a server application, then it can be cryptographically signed by the LIAR function of the server's interface services logic using one of the signing values acquired from the AIT domain controller. One example of such a signature is described below with reference to FIG. 8C.

A signing value pair includes, in one example, a randomly derived signing value 816 and a sequence number 818 unique to each individual signing value. In one embodiment, the signing value might be a cryptographically derived 128 bit number and could be stored in clear text within the signing value pair. The sequence number could be encrypted by the AIT domain controller using a key known only to the AIT domain controller.

In one embodiment, the process of signing might include, for instance, a Message-Digest Algorithm (e.g., MD5 described in Request For Comments (RFC) 1321 of Internet Engineering Task Force (IETF) (1992) or a Secure Hash Algorithm (SHA, specified by the Secure Hash Standard, Federal Information Processing Standards Publication 180-1 (1995)) for decomposition of the previously constructed identity translation token, followed by the symmetric encryption of the decomposition result producing the signature. The symmetric encryption could be carried out employing, for example, Triple Data Encryption Standard (TDES, specified in the Federal Information Processing Standards Publication 46-3 (1999)). The signature is then appended to the identity translation token along with the encrypted sequence number of the individual signing value.

In one embodiment, a number of signing values issued to a server's interface services logic during server session initialization or at the interface services' request can be determined by an interface services configuration parameter. Further, a set of signing values generated by the domain controller might be stored only for a current server session.

In another embodiment, the AIT domain controller can maintain a master list of all sets of signing values that have been issued, associating a particular signing value set with the interface services logic that requested it. The master list could be hardened for recovery purposes. The master list may also be replicated, along with replicated functional implementations of the domain controller, as necessary to support the validation load that is possible from multiple request servers.

In a further embodiment, the AIT domain controller might have the capability of sending messages to interface services within its trust domain, to inform interface services and the computing units employing them to, e.g., purge their caches of identity translation tokens and identity translation token references that may have been retired because of an administrative command directed at the AIT domain controller, possibly resulting from an administrative action. In one example, this might occur if the end user is “retired” from the enterprise including the trust domain, and all in-transit transactions initiated by this user are to be restrained from further propagation.

An AIT domain controller, in yet another embodiment, can age-off an identity translation token stored in its retention memory, so that identity translation tokens can be moved to lower levels of storage, i.e., from main memory to hard drive, and eventually to archive where they would become inactive.

FIGS. 9-14 depict various different aspects and advantages of the authenticated identity translation (AIT) technique described herein.

FIG. 9 illustrates an example of the AIT processing flow when a single initial authentication server inter-operates with multiple request servers having disparate user registries.

The computing environment of the FIG. 9 includes an AIT trust domain containing an initial authentication server 902, multiple subsequent servers 904, 906 and 908, and an AIT domain controller 910. The initial authentication server is, for instance, an iSeries server and the request servers are, for example, zSeries and pSeries servers, all offered by IBM.

When a user 900 signs 912 onto the initial authentication server and wishes to send a request to any or all of the request servers, the interface services of server 902 construct an identity translation token. In this example, the identity translation tokens are assumed to be managed by the AIT domain controller, and therefore, the LIAR function of the interface services obtains 920 an identity translation token reference (ITTR) from the domain controller, as discussed above.

The token reference is then included in the forwarded requests to the request servers. In this example, the token reference can be included in a request 914 sent over a MQSeries transaction system (offered by IBM) to request server 904, a request 916 sent over an Internet Inter-Orb Protocol (IIOP) to request server 906, and a request 918 sent over Customer Information Control System (CISC) transaction system (offered by IBM) to request server 908. Each of the request servers employs a SUIR function in its interface services logic (as discussed above) to resolve 922, 924 and 926, correspondingly, the local user identity and to authenticate the user locally.

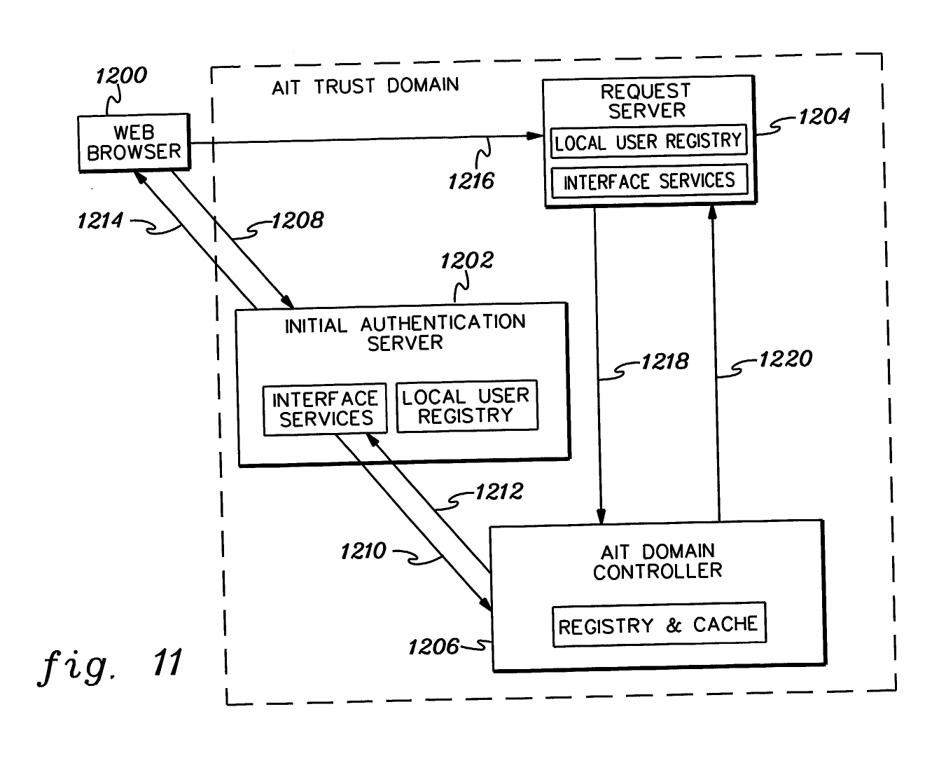

FIG. 10 illustrates an AIT process flow when multiple initial authentication servers function as front end processing to multiple request servers; in addition to AIT with multiple disparate request server user registries and multiple hops between servers. The AIT trust domain of FIG. 10 includes two initial authentication servers 1104 and 1106, three request servers 1108, 1110 and 1114 and an AIT domain controller 1112. A first user 1100 signs 1116 onto initial authentication server 1104, e.g., using Public Key Infrastructure (PKI), and a second user 1102 signs 1118 onto initial authentication server 1106, e.g., over Kerberos. The servers of the AIT trust domain are, for instance, iSeries, zSeries, pSeries and xSeries servers, all offered by IBM. Further, in this example the identification and authentication event records are assumed to be managed by the AIT domain controller.

Requests from both users propagate 1120 and 1124 to a single request server 1108. Server 1108 then performs server user identity resolution 1128 and 1130 for both requests using the domain controller as explained above, and allows both users to be signed on.

The request of first user 1100 further needs to access request server 1114. In this case, the request server 1108 now serves as an initial authentication server and performs a LIAR function for the first user. The user's request then propagates 1126 to request server 1114. Subsequently, request server 1114 performs SUIR 1134 as described above, and signs the first user on.

Similarly, the second user's request propagates 1122 to request server 1110, i.e., after request server 1108 performs a LIAR function for the second user, and the second user signs onto request server 1110.

Thus, in this example, authenticated identity translation also occurs on the intermediate server 1108.

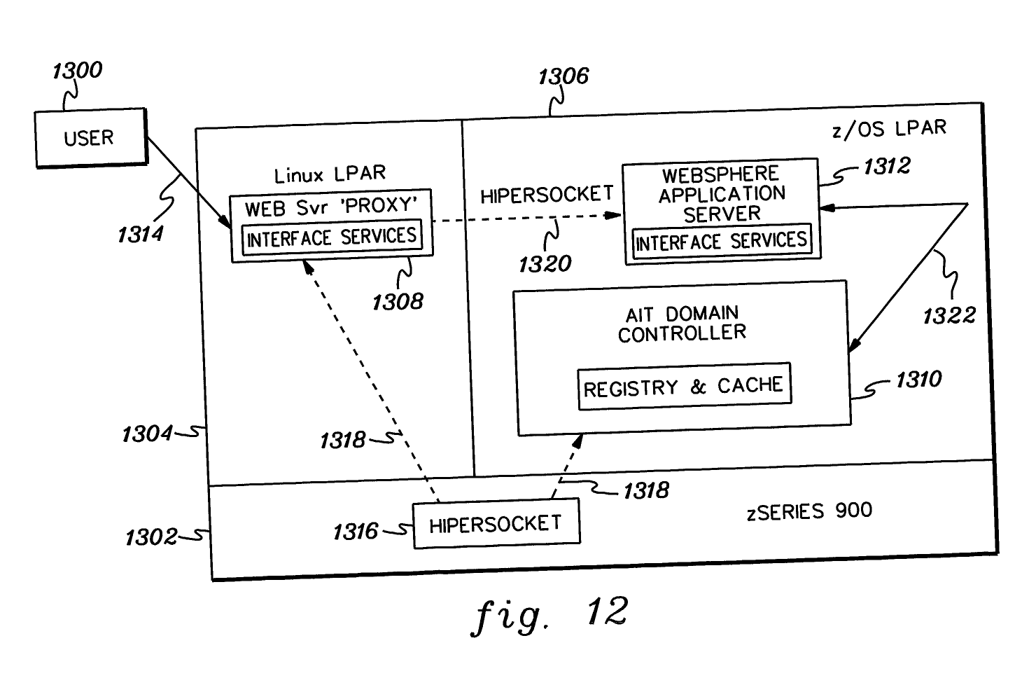

Another example of an authenticated identity translation scenario is shown in FIG. 11. This example illustrates application of authenticated identity translation to web surfing.

In this example, the AIT trust domain includes an initial authentication server 1202, a Hypertext Markup Language (HTML) request server 1204 and an AIT domain controller 1206. Further, in this example, the identification and authentication event records are assumed to be managed by the browser after being signed on by the initial authentication server. In this scenario, it may be convenient to employ browser cookies to carry a record of the identification and authentication event, i.e., a cookie can contain the identity translation token (ITT).

Initially, initial authentication server 1202 requests 1210 that the AIT domain controller provide 1212 a set of signing value pairs.

When the web browser 1200 is identified and authenticated 1208 at the initial authentication server, a signed identity translation token is constructed by the LIAR function, and returned 1214 to the web browser as a cookie.

The cookie is retained by the web browser and subsequently used in the HTML request header when the user sends 1216 an HTML request to the HTML request server.

The HTML request server, for example, an Apache server (i.e., a HyperText Transfer Protocol (HTTP) Server developed by the Apache Software Foundation (http://www.apache.org/)), extracts the identity translation token from the cookie, and passes the token to the SUIR function of its interface services. The SUIR function passes 1218 the identity translation token to the AIT domain controller, which maps the original user identity that it represents into the user's local identity on the HTML request server 1204, and returns 1220 that local user identity to server 1204.

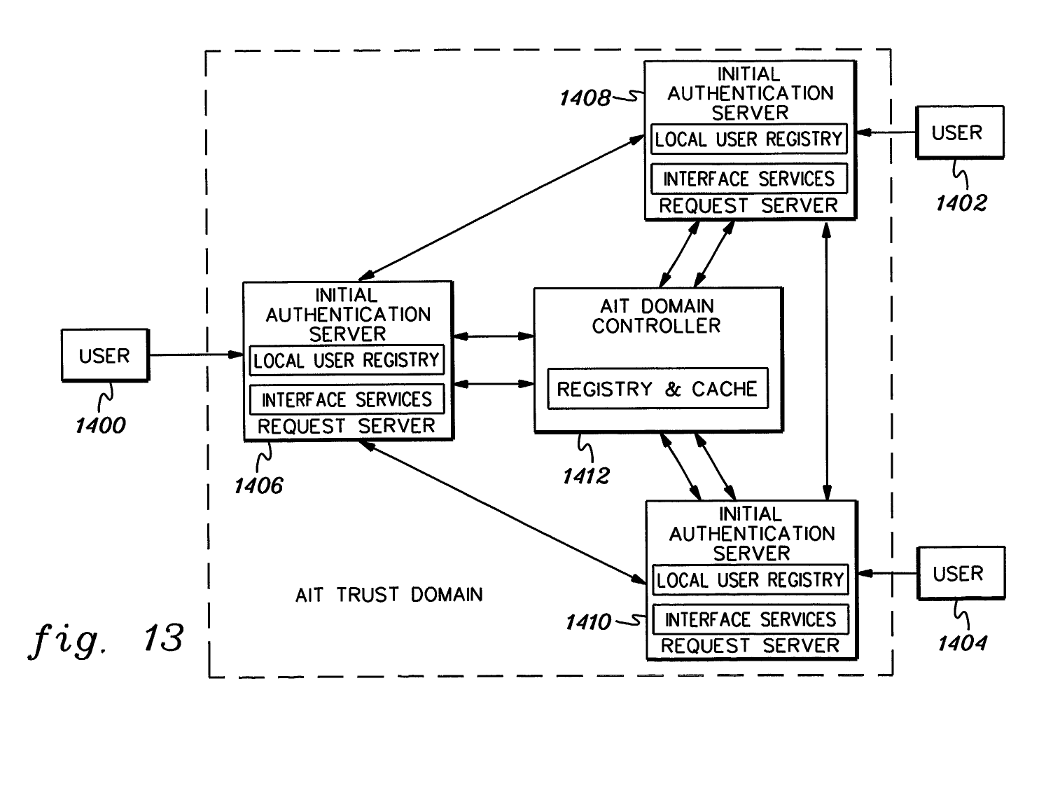

Another example of authenticated identity translation is illustrated by FIG. 12. This example is one scenario for making use of the AIT concepts presented herein in a Linux environment.

FIG. 12 depicts a zSeries 900 server 1302 configured with a z/OS logical partition (LPAR) 1306 which is running a WebSphere application server 1312. Also running in the z/OS logical partition is the AIT domain controller 1310 which includes z/OS's implementation of the interface services. The server 1302 is further configured with a Linux logical partition 1304, which is running a proxy web server 1308. In this example, a client end-user 1300 accesses 1314 the WebSphere application server from the Internet browser. The user may be using, for instance, a Digital Certificate to establish identification and authentication with the proxy web server 1308 in the Linux logical partition, and is making an SSL secured HTTP request.

After having identified and authenticated the user, the web server proxy invokes its interface services, which causes the successful identification and authentication event to be recorded 1318 in the AIT domain controller 1310 via Hipersocket 1316 (i.e., network protocol for z/OS offered by IBM). Hipersocket 1316 is assumed to have been opened when the interface services were initialized, for instance, during Linux logical partition startup.

With the recording of the identification and authentication event in the AIT domain controller and the recording of an identity translation token in the domain controller's memory, an identity translation token reference (ITTR) is returned to web server proxy 1308 via the Hipersocket 1316. The identity translation token reference is then included in the HTTP header security field when a secure HTTP request is forwarded 1320 via the Hipersocket to the WebSphere application server 1312.

The WebSphere application server 1312 treats the identity translation token reference as a user credential and passes the token reference into local security support, for instance, a Resource Access Control Facility (RACF) (via the user id and password fields of the basic authentication protocol), which passes 1322 the identity translation token reference to the AIT domain controller 1310.

The AIT domain controller uses, for example, the above-described Enterprise Identity Mapping, to map the Digital Certificate ID into a local z/OS (RACF) identity which is returned to the RACF. Then, the RACF creates an Accessor Control Element (ACEE) as if the user has accessed the WebSphere application server on z/OS directly.

Another example of an authenticated identity translation application is illustrated by FIG. 13.

FIG. 13 depicts an AIT trust domain including servers 1406, 1408 and 1410 and an AIT domain controller 1412. A user 1400 is initially identified and authenticated at server 1406, a user 1402 at server 1408, and a user 1404 at server 1410. In this example, the users' forwarded requests can be processed at any server of the AIT trust domain without further identification and authentication, since each server acts as an initial application server from its respective user's point of view, and as a request server from the point of view of any other server within the trust domain.

In this example, the authenticated identity translation processing bypasses the requirement for a proxy server, which would otherwise be required to arrange a similar environment.

To summarize, described above are various examples of authenticated identity translation in accordance with the present invention. An authenticated identity translation method, as well as techniques for identifying and authenticating users in a multi-computing environment, are provided. The various techniques described herein are applicable to single systems, homogeneous systems, as well as heterogenous systems. As one example, the initial authentication server, AIT domain controller and request server(s) can be located on different partitions of the same physical machine.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. An authenticated identity translation method comprising:
establishing an authenticated user identity responsive to an identification and authentication event within a domain comprising an initial authentication unit and a subsequent authentication unit, said identification and authentication event occurring at said initial authentication unit, said initial authentication unit and said subsequent authentication unit employing disparate user registries with different user identities;
generating a token representative of said identification and authentication event to be forwarded to said subsequent authentication unit; and
translating the authenticated user identity of said initial authentication unit to a local user identity of said subsequent authentication unit, wherein said subsequent authentication unit initiates said translating employing said token.

2. The method of claim 1, wherein the domain further comprises a domain controller, and wherein said method further comprises forwarding said token from said subsequent authentication unit to said domain controller, and said translating further comprises using said token to translate by the domain controller the authenticated user identity to the local user identity, wherein said translating includes employing a global registry of said different user identities maintained by the domain controller to translate the authenticated user identity into the local user identity for the subsequent authentication unit.

3. The method of claim 2, wherein the token comprises a translation token, said translation token including at least some of an identity of the initial authentication unit, a user identity, a method of authentication employed, and a time stamp representative of time of authentication.

4. The method of claim 3, wherein said generating further comprises obtaining signing value pair information from the domain controller, and signing the translation token using said signing value pair.

5. The method of claim 4, wherein said translating by the domain controller further comprises validating the translation token signature prior to said translating of the authenticated user identity to the local user identity using the global registry of different user identities.

6. The method of claim 5, wherein said signing value pair comprises a signing value and a sequence number, and wherein said sequence number is encrypted by the domain controller employing an encryption key known only to the domain controller, and said validating includes employing the encryption key to validate the translation token.

7. The method of claim 3, wherein said generating further comprises providing the translation token to the domain controller, storing the translation token by the domain controller and obtaining a token reference, said token reference comprising an index to said stored translation token of the domain controller, wherein said forwarding and said translating employ said token reference.

8. The method of claim 7, wherein said translating further comprises employing said token reference to retrieve said translation token by the domain controller, and thereafter using said translation token to find the local user identity in the global registry of different user identities.

9. The method of claim 2, further comprising authenticating the local user identity at the subsequent authentication unit, said authenticating being based on a return code received from the domain controller with the local user identity, said return code being based on at least one authentication policy for the domain.

10. The method of claim 9, wherein said at least one authentication policy is at least one of user dependent or method of authentication dependent for said subsequent authentication unit, and wherein the method of authentication comprises a method of authentication employed by said establishing of said authenticated user identity at said initial authentication unit.

11. The method of claim 2, further comprising repeating said method for at least one additional subsequent authentication unit, wherein with each repeating, said subsequent authentication unit becomes said initial authentication unit and said at least one additional subsequent authentication unit becomes said subsequent authentication unit, wherein said domain controller is employed by each at least one additional subsequent authentication unit in translating the token to a respective local user identity.

12. The method of claim 2, wherein said generating occurs at said initial authentication unit.

13. The method of claim 1, wherein the domain comprises a trust domain, and wherein the method further comprises initially establishing said trust domain within which the authenticated identity translation is to occur.

14. The method of claim 1, wherein said initial authentication unit comprises an initial server, and said subsequent authentication unit comprises at least one subsequent server, wherein the at least one subsequent server receives a request from the initial server, along with said token.

15. The method of claim 14, wherein said method further comprises forwarding the request and the token to multiple subsequent servers.

16. The method of claim 1, wherein said method further comprises one of forwarding the token to the subsequent authentication unit directly from the initial authentication unit or forwarding the token from the initial authentication unit through a user of the initial authentication unit to the subsequent authentication unit.

17. The method of claim 1, wherein the initial authentication unit and the subsequent authentication unit reside in different partitions of a multi-partition computing environment.

18. The method of claim 1, wherein the initial authentication unit is also another subsequent authentication unit to a further initial authentication unit establishing another authenticated user identity.

19. The method of claim 18, wherein the subsequent authentication unit comprises said further initial authentication unit.

20. The method of claim 1, further comprising repeating said method for multiple users, employing multiple initial authentication units, each requiring access to at least one subsequent authentication unit.

21. The method of claim 1, wherein said domain comprises a heterogeneous computing network, and wherein said initial authentication unit and said subsequent authentication unit comprise heterogeneous computing units.

22. The method of claim 1, wherein the domain further comprises a domain controller, and wherein said translating further comprises using said token to translate by the domain controller the authenticated user identity to the local user identity, wherein the domain controller functions as a server and the initial authentication unit and subsequent authentication unit function as clients in a client/server based model.

23. The method of claim 1, wherein the generating further comprises securing the token against modification prior to said forwarding of the token to said subsequent authentication unit.

24. The method of claim 1, wherein a structure of said token is programmable by an administrator of said domain.

25. The method of claim 1, wherein the domain further comprises a domain controller, and wherein said method further comprises performing by the domain controller at least one of retiring the token or purging the token subsequent to said translating.

26. The method of claim 1, wherein said method further comprises employing a secure protocol to transfer a request and said token from said initial authentication unit to said subsequent authentication unit.

27. An authenticated identity translation system comprising:
means for establishing an authenticated user identity responsive to an identification and authentication event within a domain comprising an initial authentication unit and a subsequent authentication unit, said identification and authentication event occurring at said initial authentication unit, said initial authentication unit and said subsequent authentication unit employing disparate user registries with different user identities;
means for generating a token representative of said identification and authentication event to be forwarded to said subsequent authentication unit; and
means for translating the authenticated user identity of said initial authentication unit to a local user identity of said subsequent authentication unit, wherein said subsequent authentication unit initiates said translating employing said token.

28. The system of claim 27, wherein the domain further comprises a domain controller, and wherein said system further comprises means for forwarding said token from said subsequent authentication unit to said domain controller, and said means for translating further comprises means for using said token to translate by the domain controller the authenticated user identity to the local user identity, wherein said means for translating includes means for employing a global registry of said different user identities maintained by the domain controller to translate the authenticated user identity into the local user identity for the subsequent authentication unit.

29. The system of claim 28, wherein the token comprises a translation token, said translation token including at least some of an identity of the initial authentication unit, a user identity, a method of authentication employed, and a time stamp representative of time of authentication.

30. The system of claim 29, wherein said means for generating further comprises means for obtaining signing value pair information from the domain controller, and for signing the translation token using said signing value pair.

31. The system of claim 30, wherein said means for translating by the domain controller further comprises means for validating the translation token signature prior to translating of the authenticated user identity to the local user identity using the global registry of different user identities.

32. The system of claim 31, wherein said signing value pair comprises a signing value and a sequence number, and wherein said sequence number is encrypted by the domain controller employing an encryption key known only to the domain controller, and said means for validating includes means for employing the encryption key to validate the translation token.

33. The system of claim 29, wherein said means for generating further comprises means for providing the translation token to the domain controller, means for storing the translation token by the domain controller and means for obtaining a token reference, said token reference comprising an index to said stored translation token by the domain controller, wherein said means for forwarding and said means for translating employ said token reference.

34. The system of claim 33, wherein said means for translating further comprises means for employing said token reference to retrieve said translation token by the domain controller, and thereafter for using said translation token to find the local user identity in the global registry of different user identities.

35. The system of claim 28, further comprising means for authenticating the local user identity at the subsequent authentication unit, said authenticating being based on a return code received from the domain controller with the local user identity, said return code being based on at least one authentication policy for the domain.

36. The system of claim 35, wherein said at least one authentication policy is at least one of user dependent or method of authentication dependent for said subsequent authentication unit, and wherein the method of authentication comprises a method of authentication employed by said means for establishing of said authenticated user identity at said initial authentication unit.

37. The system of claim 28, further comprising means for repeating said system for at least one additional subsequent authentication unit, wherein with each repeating, said subsequent authentication unit becomes said initial authentication unit and said at least one additional subsequent authentication unit becomes said subsequent authentication unit, wherein said domain controller is employed by each at least one additional subsequent authentication unit in translating the token to a respective local user identity.

38. The system of claim 28, wherein said means for generating occurs at said initial authentication unit.

39. The system of claim 27, wherein the domain comprises a trust domain, and wherein the system further comprises means for initially establishing said trust domain within which the authenticated identity translation is to occur.

40. The system of claim 27, wherein said initial authentication unit comprises an initial server, and said subsequent authentication unit comprises at least one subsequent server, wherein the at least one subsequent server receives a request from the initial server, along with said token.

41. The system of claim 40, wherein said system further comprises means for forwarding the request and the token to multiple subsequent servers.

42. The system of claim 27, wherein said system further comprises one of means for forwarding the token to the subsequent authentication unit directly from the initial authentication unit or means for forwarding the token from the initial authentication unit through a user of the initial authentication unit to the subsequent authentication unit.

43. The system of claim 27, wherein the initial authentication unit and the subsequent authentication unit reside in different partitions of a multi-partition computing environment.

44. The system of claim 27, wherein the initial authentication unit is also another subsequent authentication unit to a further initial authentication unit establishing another authenticated user identity.

45. The system of claim 44, wherein the subsequent authentication unit comprises said further initial authentication unit.

46. The system of claim 27, further comprising means for repeating said system for multiple users, employing multiple initial authentication units, each requiring access to at least one subsequent authentication unit.

47. The system of claim 27, wherein said domain comprises a heterogeneous computing network, and wherein said initial authentication unit and said subsequent authentication unit comprise heterogeneous computing units.

48. The system of claim 27, wherein the domain further comprises a domain controller, and wherein said means for translating further comprises means for using said token to translate by the domain controller the authenticated user identity to the local user identity, wherein the domain controller functions as a server and the initial authentication unit and subsequent authentication unit function as clients in a client/server based model.

49. The system of claim 27, wherein the means for generating further comprises means for securing the token against modification prior to said forwarding of the token to said subsequent authentication unit.

50. The system of claim 27, wherein a structure of said token is programmable by an administrator of said domain.

51. The system of claim 27, wherein the domain further comprises a domain controller, and wherein said system further comprises means for performing by the domain controller at least one of retiring the token or purging the token subsequent to said translating.

52. The system of claim 27, wherein said system further comprises means for employing a secure protocol to transfer a request and said token from said initial authentication unit to said subsequent authentication unit.

53. An authenticated identity translation system comprising:
a trusted domain comprising an initial authentication unit, a subsequent authentication unit, and a domain controller, said initial authentication unit and said subsequent authentication unit employing disparate user registries with different user identities;
said initial authentication unit being adapted to establish an authenticated user identity responsive to an identification and authentication event occurring thereat, and to generate a token representative of said identification and authentication event to be forwarded to said subsequent authentication unit; and
said subsequent authentication unit being adapted to forward said token to the domain controller for translating the authenticated user identity of said initial authentication unit to a local user identity of said subsequent authentication unit, wherein said translating includes employing said token received from said initial authentication unit.

54. At least one program storage device readable by a machine, tangibly embodying at least one program of instructions executable by the machine to perform an authenticated identity translation method, said method comprising:
establishing an authenticated user identity responsive to an identification and authentication event within a domain comprising an initial authentication unit and a subsequent authentication unit, said identification and authentication event occurring at said initial authentication unit, said initial authentication unit and said subsequent authentication unit employing disparate user registries with different user identities;
generating a token representative of said identification and authentication event to be forwarded to said subsequent authentication unit; and
translating the authenticated user identity of said initial authentication unit to a local user identity of said subsequent authentication unit, wherein said subsequent authentication unit initiates said translating employing said token.

55. The at least one program storage device of claim 54, wherein the domain further comprises a domain controller, and wherein said method further comprises forwarding said token from said subsequent authentication unit to said domain controller, and said translating further comprises using said token to translate by the domain controller the authenticated user identity to the local user identity, wherein said translating includes employing a global registry of said different user identities maintained by the domain controller to translate the authenticated user identity into the local user identity for the subsequent authentication unit.

56. The at least one program storage device of claim 55, wherein the token comprises a translation token, said translation token including at least some of an identity of the initial authentication unit, a user identity, a method of authentication employed, and a time stamp representative of time of authentication.

57. The at least one program storage device of claim 56, wherein said generating further comprises obtaining signing value pair information from the domain controller, and signing the translation token using said signing value pair.

58. The at least one program storage device of claim 57, wherein said translating by the domain controller further comprises validating the translation token signature prior to said translating of the authenticated user identity to the local user identity using the global registry of different user identities.

59. The at least one program storage device of claim 58, wherein said signing value pair comprises a signing value and a sequence number, and wherein said sequence number is encrypted by the domain controller employing an encryption key known only to the domain controller, and said validating includes employing the encryption key to validate the translation token.

60. The at least one program storage device of claim 56, wherein said generating further comprises providing the translation token to the domain controller, storing the translation token by the domain controller and obtaining a token reference, said token reference comprising an index to said stored translation token of the domain controller, wherein said forwarding and said translating employ said token reference.

61. The at least one program storage device of claim 60, wherein said translating further comprises employing said token reference to retrieve said translation token by the domain controller, and thereafter using said translation token to find the local user identity in the global registry of different user identities.

62. The at least one program storage device of claim 55, further comprising authenticating the local user identity at the subsequent authentication unit, said authenticating being based on a return code received from the domain controller with the local user identity, said return code being based on at least one authentication policy for the domain.

63. The at least one program storage device of claim 62, wherein said at least one authentication policy is at least one of user dependent or method of authentication dependent for said subsequent authentication unit, and wherein the method of authentication comprises a method of authentication employed by said establishing of said authenticated user identity at said initial authentication unit.

64. The at least one program storage device of claim 55, further comprising repeating said method for at least one additional subsequent authentication unit, wherein with each repeating, said subsequent authentication unit becomes said initial authentication unit and said at least one additional subsequent authentication unit becomes said subsequent authentication unit, wherein said domain controller is employed by each at least one additional subsequent authentication unit in translating the token to a respective local user identity.

65. The at least one program storage device of claim 55, wherein said generating occurs at said initial authentication unit.

66. The at least one program storage device of claim 54, wherein the domain comprises a trust domain, and wherein the method further comprises initially establishing said trust domain within which the authenticated identity translation is to occur.

67. The at least one program storage device of claim 54, wherein said initial authentication unit comprises an initial server, and said subsequent authentication unit comprises at least one subsequent server, wherein the at least one subsequent server receives a request from the initial server, along with said token.

68. The at least one program storage device of claim 67, wherein said method further comprises forwarding the request and the token to multiple subsequent servers.

69. The at least one program storage device of claim 54, wherein said method further comprises one of forwarding the token to the subsequent authentication unit directly from the initial authentication unit or forwarding the token from the initial authentication unit through a user of the initial authentication unit to the subsequent authentication unit.

70. The at least one program storage device of claim 54, wherein the initial authentication unit and the subsequent authentication unit reside in different partitions of a multi-partition computing environment.

71. The at least one program storage device of claim 54, wherein the initial authentication unit is also another subsequent authentication unit to a further initial authentication unit establishing another authenticated user identity.

72. The at least one program storage device of claim 71, wherein the subsequent authentication unit comprises said further initial authentication unit.

73. The at least one program storage device of claim 54, further comprising repeating said method for multiple users, employing multiple initial authentication units, each requiring access to at least one subsequent authentication unit.

74. The at least one program storage device of claim 54, wherein said domain comprises a heterogeneous computing network, and wherein said initial authentication unit and said subsequent authentication unit comprise heterogeneous computing units.

75. The at least one program storage device of claim 54, wherein the domain further comprises a domain controller, and wherein said translating further comprises using said token to translate by the domain controller the authenticated user identity to the local user identity, wherein the domain controller functions as a server and the initial authentication unit and subsequent authentication unit function as clients in a client/server based model.

76. The at least one program storage device of claim 54, wherein the generating further comprises securing the token against modification prior to said forwarding of the token to said subsequent authentication unit.

77. The at least one program storage device of claim 54, wherein a structure of said token is programmable by an administrator of said domain.

78. The at least one program storage device of claim 54, wherein the domain further comprises a domain controller, and wherein said method further comprises performing by the domain controller at least one of retiring the token or purging the token subsequent to said translating.

79. The at least one program storage device of claim 54, wherein said method further comprises employing a secure protocol to transfer a request and said token from said initial authentication unit to said subsequent authentication unit.
